(19) United States
(12) Patent Application Publication
(10) Pub. No.: US 2008/0026792 A1
(43) Pub. Date: Jan. 31, 2008

(54) MOBILE TERMINAL AND METHOD OF CAPTURING IMAGE THEREOF

(76) Inventor: Joo Hee SON, Seoul (KR)

Correspondence Address: BIRCH STEWART KOLASCH & BIRCH, PO BOX 747, FALLS CHURCH, VA, 22040-0747, US

(21) Appl. No.: 11/828,923

(22) Filed: Jul. 26, 2007

(30) Foreign Application Priority Data
Jul. 27, 2006 (KR) 10-2006-0070646

(51) Int. Cl. H04M 1/00; G06F 3/041; H04H 1/00

(52) U.S. Cl. 455/556.1; 345/173; 455/3.01; 455/3.06; 455/566

(57) ABSTRACT

A terminal and method of capturing an image thereof, by which a user can accurately capture a specific image in the course of viewing images. An embodiment of the present invention includes if a specific timing point is selected while images are displayed, displaying images for a prescribed time corresponding to the specific timing point per a prescribed number of frames; and if at least one of the images displayed per the prescribed number of frames is selected, capturing the selected at least one image.

This application claims the benefit of the Korean Patent Application No. 10-2006-0070646, filed on Jul. 27, 2006, which is hereby incorporated by reference as if fully set forth herein.

### BACKGROUND OF THE INVENTION

1. Field of the Invention

The present invention relates to image storage, and more particularly, to a terminal and method of capturing an image thereof.

2. Discussion of the Related Art

Generally, the remarkable developments of the information communication technologies bring rapid transitions of information and communication environments. A mobile communication terminal is regarded as a necessity in a modern society to be globally used.

In order to meet the user's demand according to the base expansion of the mobile communication terminals, various functions including a broadcast reception as well as a general voice call are provided to the mobile communication terminal.

A function of mobile broadcast reception tends to converge with a basic function of a mobile communication terminal. Owing to this technological convergence, an image received via mobile broadcasting is captured to be used as a background image of the mobile communication terminal. And, the captured image can be transmitted to a third party via MMS (multimedia messaging service).

However, in case of attempting to capture a specific image found in the course of viewing the received broadcast images, it frequently happens that a wrong image is captured due to an inevitable time difference between a timing point of finding the specific image and another timing point of attempting to capture the specific image.

### SUMMARY OF THE INVENTION

Accordingly, the present invention is directed to a terminal and method of capturing an image that substantially obviate one or more problems due to limitations and disadvantages of the related art.

An object of the present invention is to provide a terminal and method of capturing an image, by which a user can accurately capture a specific image in the course of viewing images.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of capturing an image in a terminal according to an embodiment of the present invention includes if a specific timing point is selected while images are displayed, displaying images for a prescribed time corresponding to the specific timing point per a prescribed number of frames; and if at least one of the images displayed per the prescribed number of frames is selected, capturing the selected at least one image.

In another aspect of the present invention, a terminal includes a display unit, a memory unit, and a control unit configured to, if a specific timing point is selected while the display unit displays images, display images for a prescribed time corresponding to the specific timing point per a prescribed number of frames, and, if at least one of the images displayed per the number of the frames is selected, to capture the selected at least one image in the memory unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a schematic block diagram of a mobile terminal according to an embodiment of the present invention;

FIG. 2 is a diagram of image transition on a display unit screen of a mobile terminal capable of implementing an image capturing method according to a first embodiment of the present invention;

FIG. 3 is a flowchart of an image capturing method according to the first embodiment of the present invention;

FIG. 4 is a diagram of image transition on a display unit screen of a mobile terminal capable of implementing an image capturing method according to a second embodiment of the present invention; and

FIG. 5 is a flowchart of an image capturing method according to the second embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention is applicable to various kinds of mobile terminals such as a PDA (personal digital assistant), a smart phone, a mobile phone, a game player, and the like as well as a broadcast reception dedicated terminal, or a combination thereof. For convenience and simplicity of explanation in the following description, it is assumed that a mobile terminal receives a mobile broadcast. So, it should be understood that the present invention is not restricted by the following explanation and embodiments.

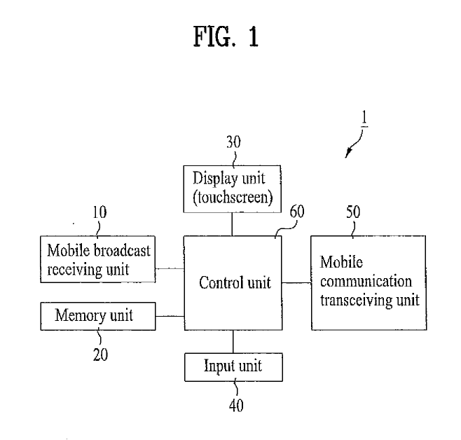

A configuration of a mobile terminal according to the present invention is explained with reference to FIG. 1 as follows.

FIG. 1 is a schematic block diagram of a mobile terminal according to an embodiment of the present invention.

Referring to FIG. 1, a mobile terminal 1 according to the present invention includes a mobile broadcast receiving unit 10, a memory unit 20, a display unit 30, an input unit 40, a mobile communication transceiving unit 50, and a control unit 60. All components of the mobile terminal 1 are operatively coupled and configured.

Of course, the mobile terminal according to the present invention can be provided with other various additional elements as well as the aforesaid elements. Yet, since the additional elements are not directly associated with the present invention, explanations for the additional elements will be omitted in the following description for concise explanation of the present invention. Meanwhile, in case of implementing the elements of the present invention for the real application, it is to be understood that at least two elements can be combined into one element or one element can be divided into at least two elements.

The above-mentioned respective elements are explained in detail as follows.

First of all, the mobile broadcast receiving unit 10 receives mobile broadcasting. In this case, the mobile broadcasting means any broadcast service capable of receiving a broadcast in the course of moving such as MediaFlo of U.S.A., DMB (digital multimedia broadcasting) of Korea, DVB-H of Europe, and the like. In case of being capable of receiving a broadcast in the course of moving, all kinds of broadcast services can belong to a category of the mobile broadcasting regardless of broadcast specifications.

The memory unit 20 plays a role in storing various kinds of software for driving various functions provided by the mobile terminal 1 and various data corresponding to the software. The memory unit 20 plays a role in storing a broadcast image received via the receiving unit 10 and an image captured according to the present invention if necessary. In particular, the memory unit 20 is capable of storing the received broadcast image(s) for a prescribed time (e.g., several seconds) after the received broadcast image has been displayed on the display unit 30. This facilitates a terminal user to select a specific image from the broadcast images displayed on the display unit 30, which will be explained in detail later.

The display unit 30 displays a real-time operation situation of the mobile terminal 1 and images according to the various functions provided by the mobile terminal 1. In particular, the display unit 30 displays images captured according to the present invention. Preferably, the display unit 30 includes a touchscreen.

The input unit 40 (e.g., key pads, buttons, etc.) enables the terminal user to input various commands or information to the mobile terminal 1. If the display unit 30 does not include the touchscreen, a separate input unit is a mandatory element of the mobile terminal to input the various commands and information. Otherwise, the input unit 40 can be omitted.

The mobile communication transceiving unit 50 enables the mobile terminal to perform voice communication with a third party, SMS (short message service) communication, MMS (multimedia messaging service) communication, and the like. If the mobile communication is not necessary to the mobile terminal, the mobile communication transceiving unit 50 can be omitted

And, the control unit 60 plays a role in controlling the overall terminal including the mobile broadcast transceiving unit 10, the memory unit 20, the display unit 30, the input unit 40, and the mobile communication transceiving unit 50. In particular, the control unit 60 can mutually control the elements to enable an image capturing method according to the present invention to be implemented in the mobile terminal 1.

In addition, the control unit 60 is able to control the elements of the mobile terminal 1 to store the real-time received broadcast via the memory unit 20 and reproduce the broadcast collectively after a prescribed duration. For instance, the control unit 60 is able to control the mobile terminal 1 to delay (or time shift) the real-time received broadcast to be reproduced for a certain duration, e.g., 5 minutes if necessary. This enables a broadcast, which is received by real time in the course of capturing images according to the present invention, to be fully viewed after completion of the image capturing process. This will be explained later.

An image capturing method according to an embodiment of the present invention implemented by the above-configured mobile terminal 1 is explained as follows. In the following embodiments, it is assumed that the display unit 30 of the mobile terminal 1 includes a touchscreen. Yet, even if the display unit 30 does not include the touchscreen, the embodiments can be implemented through a key manipulation of the input unit 40. So, it should be understood that the present invention is applicable to other cases as well as the case where the display unit includes the touch screen. Also, these embodiments can be equally implemented by other types of mobile terminals.

### First Embodiment

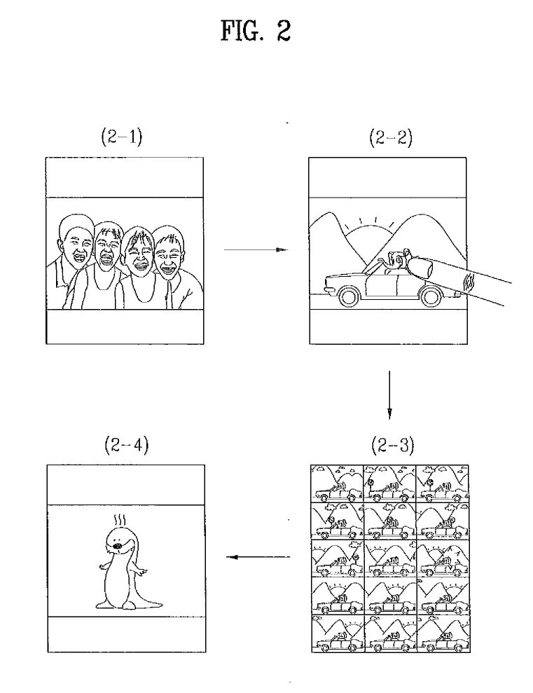

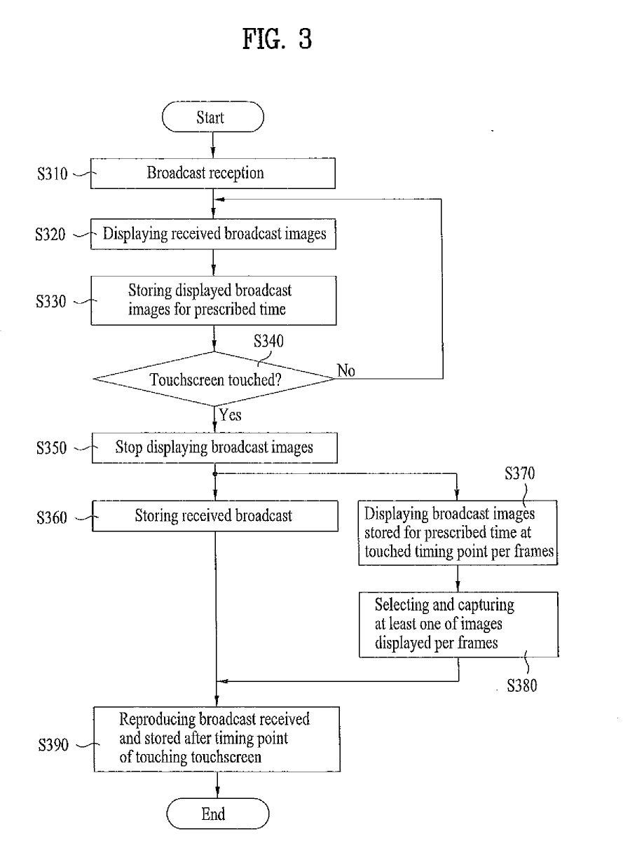

An image capturing method according to a first embodiment of the present invention is explained with reference to FIG. 2 and FIG. 3 as follows.

FIG. 2 is a diagram of image transition on a display unit screen of a mobile terminal capable of implementing an image capturing method according to a first embodiment of the present invention, and FIG. 3 is a flowchart of an image capturing method according to the first embodiment of the present invention.

First of all, the mobile terminal 1, as shown in (2-1) of FIG. 2, displays an image of a mobile broadcast received in real time on the touch screen (display unit) 30 [S310, S320].

The mobile terminal 1 temporarily stores the images already displayed on the touchscreen for a prescribed time (e.g., about 0.5 second) [S330]. So, the images corresponding to the prescribed time of 0.5 second prior to a real time played image keeps being temporarily stored after having been displayed. For example, in case of terrestrial DMB of Korea, since a per second frame number is 30 frames/second, images of 15 frames corresponding to 0.5 second are temporarily and continuously stored in the mobile terminal after having been displayed. For instance, each displayed image may be stored for about 0.5 seconds in the memory unit 20, before the image is discarded or processed in some other way. This would apply to all received images in the broadcast.

When a terminal user is viewing the images of the mobile broadcast being displayed, and a specific image being displayed is desired to be captured, the terminal user, as shown in (2-2) of FIG. 2, touches the touchscreen 30 currently displaying the desired image or selects/clicks on the screen using the input unit 40 [S340].

If so, the mobile terminal 1 stops displaying the next real-time received images, but keeps storing them as they are consecutively received in real time after the touch screen has been touched [S350, S360].

The images temporarily stored for the prescribed time at the specific timing point of touching the touchscreen 30, as shown in (2-3) of FIG. 2, are displayed per frame [S370]. Namely, if the images corresponding to 0.5 second are temporarily stored, 15 frames corresponding to 0.5 second are displayed.

In case that images for 1 second are temporarily stored, 30 frames corresponding to 1 second are displayed or 15 frames of the 30 frames are displayed by skipping one another. The aforesaid prescribed time and the frame number are just examples and other values can be used as desired.

If the terminal user touches a specific image shown in (2-3) of FIG. 2 in the displayed frames, the touched image is captured and stored [S380]. Optionally, at least two images can be touched and captured if necessary.

Then, the mobile terminal resumes displaying the images separately stored at step S360 after the display stop timing point, as shown in (2-4) of FIG. 2 [S390]. For example, if 15 seconds are taken to capture the specific image(s), the mobile terminal resumes displaying the real-time received broadcast by delaying it by 15 seconds. Hence, the terminal user is able to fully view all the images broadcast during the time taken to capture the specific image(s). That is, by separately storing the currently received broadcast while the user selects a particular image to be captured and then by reproducing the stored broadcast, none of the real-time broadcast images are lost and the user can view all the received broadcast images. The captured image(s) can be later displayed or sent to other device(s) as desired.

### Second Embodiment

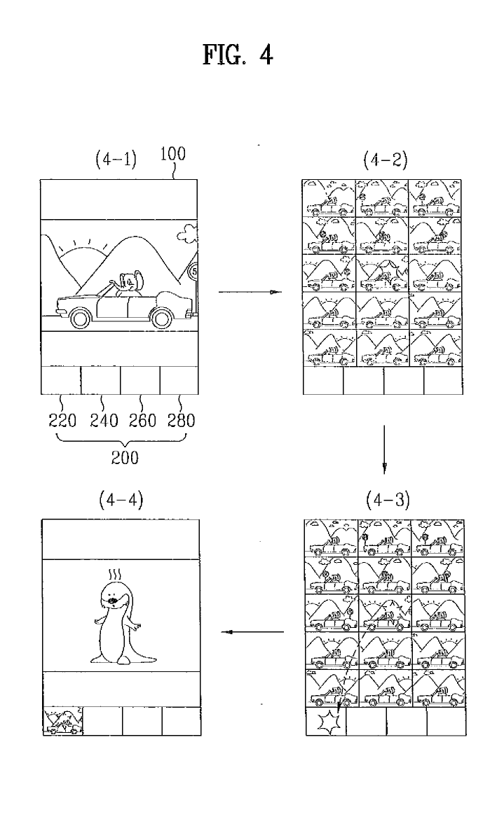

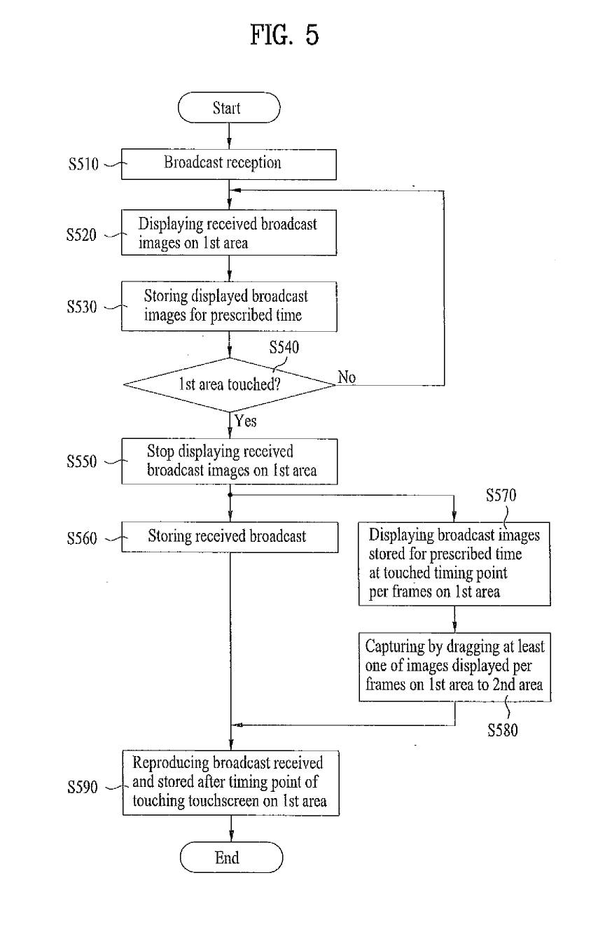

An image capturing method according to a second embodiment of the present invention is explained with reference to FIG. 4 and FIG. 5 as follows.

FIG. 4 is a diagram of image transition on a display unit screen of a mobile terminal capable of implementing an image capturing method according to the second embodiment of the present invention, and FIG. 5 is a flowchart of an image capturing method according to the second embodiment of the present invention.

Main concepts of an image capturing method according to the second embodiment of the present invention are similar to those of the first embodiment of the present invention. Yet, the second embodiment differs from the first embodiment in that a captured image is configured to keep being displayed on the touchscreen (or display unit) of the mobile terminal after the completion of the image capturing. So, the same explanations between the first and second embodiments will be omitted in the following description for the conciseness of the explanation.

First of all, a screen configuration of the touch screen (or the display unit) to implement the second embodiment of the present invention is explained as follows.

The touch screen (or display unit), as shown in (4-1) of FIG. 4, is divided into a first area 100 and a second area 200. The second area 200 is subdivided into at least one sub-area. For convenience of explanation, it is assumed in the following description that the second area 200 is divided into four sub-areas, i.e., first to fourth sub-areas 220, 240, 260, and 280. However, the second area 200 can be divided into any number of sub-areas.

The mobile terminal 1 displays a received image of a mobile broadcast, as shown in (4-1) of FIG. 4, on the first area 100 [S510, S520].

The mobile terminal 1 temporarily stores the images displayed on the first area 100 for a prescribed time [S530]. For instance, each image displayed on the display unit 30 may be temporarily stored in the memory unit 20 for about 0.5 seconds before it is discarded or processed in other way. This would apply to all displayed images in the broadcast.

When a terminal user is viewing the images displayed on the first area 100, if a certain image the user wants to capture is displayed, then the terminal user touches the first area 100 or selects/clicks on the first area 100 using the input unit 40 [S540].

If so, the mobile terminal 1 stops displaying the real-time received images, but stores these images consecutively received in real-time after the touch screen has been touched [S550, S560]. That is, the broadcast images received after the first area has been touched/selected are not displayed but are stored separately for a delayed display.

And, on the first area 100, as shown in (4-2) of FIG. 4, the image temporarily stored in the mobile terminal at the timing point of touching the first area is displayed per frame [S570]. This is explained in detail in the description of the first embodiment of the present invention.

The terminal user touches a specific image, as shown in (4-3) of FIG. 4, among the frame images displayed on the first area 100, drags the touched image to the first sub-area 220 of the second area 200 (or one of the four sub-areas), and then releases the touch [S580.]

If so, the image of the touched frame is captured and displayed on the first sub-area 220 (or other designated sub-area). In this manner, each of the sub-areas can display a captured image. If the specific image is dragged to the first sub-area on which another image has been already captured and displayed, it can be configured that the specific image is captured and displayed on the first sub-area with the already (previously) captured image being erased.

After the specific image has been captured, the images stored after the display stop timing point at step S560 are displayed on the first area 100 [S590]. This is explained in detail in the description of the first embodiment of the present invention. That is, the broadcast images temporarily not displayed (but stored) are displayed on the first area 100.

Accordingly, the present invention provides the following effects or advantages.

In the related art, in case of attempting to capture a specific image found in the course of viewing received broadcast images, a wrong image is captured due to an inevitable time difference between a timing point of finding the specific image and another timing point of attempting to capture the specific image. In contrast, the present invention enables a terminal user to capture the specific image more accurately in the course of viewing the broadcast images. Further, none of the real-time received broadcast images are lost due to the capturing process. Moreover, various multiple images can be effectively and simultaneously displayed on the screen and can be captured for other use.

It will be apparent to those skilled in the art that various modifications and variations can be made in the present invention without departing from the spirit or scope of the inventions. For instance, it is apparent to those skilled in the art that an image can be captured in the course of viewing a recorded broadcast (or a moving picture and the like) without departing from the spirit or scope of the inventions. In particular, unlike the case of capturing the broadcast reception image, in case of capturing an image while recorded images are displayed, it is unnecessary to temporarily store images displayed while the recorded images are displayed. If a specific timing point is selected in the course of displaying the recorded images, images from the specific timing point to a prescribed timing point (images for a prescribed duration including the specific timing point) are displayed per frame. If one of the per frame displayed images is selected, the selected image can be configured to be stored/captured.

Moreover, since a mobile terminal is frequently utilized in capturing images, a mobile terminal capable of receiving mobile broadcasting is taken only as an example for the description of preferred embodiments of the present invention. So, it is apparent to those skilled in the art that the aforesaid embodiments of the present invention are applicable to normal broadcast reception terminals.

Thus, it is intended that the present invention cover the modifications and variations of this invention provided they come within the scope of the appended claims and their equivalents.

What is claimed is:

1. A method of capturing an image in a terminal, comprising:
if a specific timing point is selected while images are displayed, displaying images for a prescribed time corresponding to the specific timing point per a prescribed number of frames; and
if at least one of the images displayed per the prescribed number of frames is selected, capturing the selected at least one image.

2. The method of claim 1, wherein the images are real-time received broadcast images, and
wherein the displaying step comprises:
storing the displayed images for the prescribed time, and
if the specific timing point is selected, displaying the images stored at the specific timing point per the frames.

3. The method of claim 2, further comprising:
if the specific timing point is selected, storing broadcast images received in real time after the specific timing point; and
after the selected image has been captured, displaying the images stored after the specific timing point.

4. The method of claim 1, wherein the terminal comprises a touch screen, and the touch screen is divided into a first area and a second area.

5. The method of claim 4, wherein in the displaying step, an image prior to the specific timing point is displayed on the first area.

6. The method of claim 5, wherein in the displaying step, the specific timing point is a timing point when the first area is touched by a user.

7. The method of claim 6, wherein in the displaying step, the per frame images are displayed on the first area after the specific timing point.

8. The method of claim 7, wherein in the capturing step, the at least one image is selected by touching the at least one image displayed on the first area after the specific timing point.

9. The method of claim 8, wherein the capturing step further includes displaying the captured image on the second area.

10. The method of claim 4, wherein the capturing step includes:
selecting at least one image displayed per the prescribed number of frames;
dragging the selected at least one image to a portion of the second area; and
releasing the dragging to capture the dragged at least one image in association with the portion of the second area.

11. A terminal comprising:
a display unit;
a memory unit; and
a control unit configured to, if a specific timing point is selected while the display unit displays images, display images for a prescribed time corresponding to the specific timing point per a prescribed number of frames, and, if at least one of the images displayed per the number of the frames is selected, to capture the selected at least one image in the memory unit.

12. The terminal of claim 11, wherein the images are broadcast images received by real time,
wherein the control unit stores the displayed images for the prescribed time, and
wherein if the specific timing point is selected, the control unit displays the images stored at the specific timing point per the frames.

13. The terminal of claim 12, wherein if the specific timing point is selected, the control unit stores broadcast images received in real time after the specific timing point, and
wherein after the selected at least one image has been captured, the control unit displays the images stored after the specific timing point.

14. The terminal of claim 11, wherein the display unit comprises a touch screen, and the touch screen is divided into a first area and a second area.

15. The terminal of claim 14, wherein the control unit displays an image prior to the specific timing point on the first area.

16. The terminal of claim 15, wherein the control unit recognizes a moment when the first area is touched by a user as the specific timing point.

17. The terminal of claim 16, wherein the control unit displays the images per the prescribed number of the frames on the first area after the specific timing point.

18. The terminal of claim 17, wherein the control unit recognizes that the at least one image is selected when the at least one images displayed per the prescribed number of the frames on the first area is touched and dragged.

19. The terminal of claim 18, wherein the control unit displays the captured image on the second area.

20. The terminal of claim 14, wherein the control unit captures the at least one image by:
selecting at least one image displayed per the prescribed number of frames;
dragging the selected at least one image to a portion of the second area; and
releasing the dragging to capture the dragged at least one image in association with the portion of the second area.
